(19) United States
(12) Patent Application Publication
(10) Pub. No.: US 2024/0241021 A1
(43) Pub. Date: Jul. 18, 2024

(54) Filter Sampling Bag

(71) Applicant: Interscience, St Nom la Breteche (FR)

(72) Inventor: Emmanuel Jalenques, St Nom la Breteche (FR)

(21) Appl. No.: 18/581,894

(22) Filed: Feb. 20, 2024

Related U.S. Application Data
(63) Continuation-in-part of application No. 17/372,822, filed on Jul. 12, 2021, now abandoned.

(30) Foreign Application Priority Data
Jul. 28, 2020 (FR) 2007977

(51) Int. Cl. G01N 1/40; B01L 3/00

(52) U.S. Cl. CPC G01N 1/4077; B01L 3/505; G01N 2001/4088

(57) ABSTRACT

A filter sampling bag for use in a mixer for the preparation of samples for carrying out analyses and/or microbiological tests, the sampling bag formed from a plastic and having a bottom, side walls, and a mouth opening. The sampling bag is compartmentalized by a filtering partition delimiting a receiving chamber for a sample and a sampling chamber to permit a taking of samples. The sampling bag is marked with a visual indicator of a correct, predetermined closing position of the sampling bag after mixing. A combination or kit for the preparation of samples comprises a mixer and a filter sampling bag. Further disclosed is a method of manufacturing such a filter sampling bag for use in a mixer for the preparation of samples to permit analyses and/or microbiological tests.

### RELATED APPLICATION

This application is a continuation-in-part of application Ser. No. 17/372,822, filed Jul. 17, 2021, which claims priority to French Application No. 2007977, filed Jul. 28, 2020.

### FIELD OF THE INVENTION

The present invention relates to the field of sample collection and preparation for analysis, and in particular to the preparation and collection of a filtrate from a solid sample. Still more particularly, embodiments of the present invention comprise a filter collection bag, such as a flat bag of transparent plastic material, compartmentalized by a filter partition to delimit a collection chamber for taking samples that can be used for the preparation of a sample filtrate from a potentially contaminating solid or liquid sample. A solid sample could be fibrous, inhomogeneous, and insoluble. In such cases, a liquid, such as a physiological or culture medium, can be placed in the bag. The sample, when placed in the compartment, is in contact with the liquid. The amount of liquid used is usually one-tenth the weight of the solid sample and usually represents only a small volume at the bottom of the bag. The filtrate can be viscous or pasty. The analysis of the filtrate can, in particular, be microbiological.

### BACKGROUND OF THE INVENTION

Filter collection bags are used in a variety of circumstances. For instance, filter bags may be used when a sample to be analyzed is solid and poorly soluble, where a sample is difficult to handle, where a sample is potentially pathogenic, and, additionally or alternatively, where the sample taken “on site” must not be contaminated. Typically, microbiological analysis processes require the dilution of solid or liquid samples to be analyzed to obtain a liquid form.

Most filter collection bags have two compartments separated by a filter. One compartment is intended to receive a solid sample while the other compartment forms a collection chamber intended to receive the filtrate. According to one possibility, the filter may be what can be referred to as a full-page type that separates the bag into two identical compartments. One compartment is intended to receive the sample and the diluent, and the other compartment is intended to collect the filtered mixture using a pipette. According to another possibility, the filter can be of a lateral type with a lateral chimney formed to divide the bag into two compartments. One compartment, which can be a larger compartment of the two, receives the sample and the diluent. The filtering partition can have a pore size, which is often measured in microns.

Sampling bags typically have dimensions of 95×180 mm for a maximum mixing volume of 100 mL, 190×200 mm for a maximum mixing volume of 400 mL, 250×380 mm for a maximum mixing volume of 2000 mL, and 380×600 mm for a maximum mixing volume of 3750 mL.

With each such embodiment, the filter collection bag with the sample and the diluents therein can be inserted into a mixer to aid in suspension of the sample and/or solubilization of solid sample objects in the liquid. After grinding, the compartment intended to receive the filtrate forms a sampling chamber that makes it possible to take the suspension obtained after filtration. All or part of the filtrate is then taken for analysis.

To prevent capillary rise and leakage from the top of the bag during mixing, the bag must be kept closed at a predetermined height. This can be done, by way of example and not limitation, by pinching the bag in the mixer door. The present inventor has devised of mixers with special closures, such as the specialized closure for mixers sold by Interscience SARL of Saint-Nom La Breteche, France under the trademark Q-Tight, to eliminate any risk of leakage from the top of the sampling bag during mixing. A lever ensures that the mixer door is locked in a closed position with the door then maintaining the bag in a closed configuration.

Following mixing, it may be necessary to close the bag temporarily, such as to place it on a bag rack for storage. To that end, after mixing, the user is required to make a fold across the width of the bag and then to install a bag clasp or any other pinching device on the fold.

The products analyzed are often fatty and facilitate the circulation of the liquid in the bag during mixing with the walls of the bag becoming greasy. As such, the walls of the bag often do not adhere to each other such that the liquid can rise to an excessive height within the bag during mixing.

Thus, under the effect of mixing, the liquid contained in the bag rises and permeates the filter, which acts like a blotter and absorbs the contaminated medium. During this step, if the closure is too low and is below the pinch area of the mixer door maintaining pressure during mixing, the medium contained in the bag is frequently spilled from the bag. That discharge may be more or less rapid, and the user may not immediately notice their error in making the bend. In addition, the volume of liquid increases under the effect of heat and bacterial growth to be analyzed during an enrichment and incubation step. With prior art bags, the potentially contaminating medium contained in the bag thus frequently spills outside of the bag.

The foregoing problems have existed in the art for some time. There is a recognized need for a filter sampling bag that presents a viable solution to these recognized problems.

### SUMMARY OF THE INVENTION

According to a first aspect of the invention, there is provided a filter sampling bag that, when empty, is preferably flat and transparent with a bottom, side walls, and a mouth opening. The bag is formed from a plastic material and is compartmentalized using a filtering partition with a pore size. The filtering partition delimits a chamber for receiving a sample and a sampling chamber permitting a taking of samples. The bag has a visual indicator of a correct closing position of the bag. With such an indicator, the user is apprised of where to make a fold in the bag to close the bag while avoiding spillage and capillary action of the medium contained in the bag from the inside to the outside of the bag.

According to one possibility, the visual indicator is disposed on the bag at a distance from the opening substantially equal to one third of the height of the bag. Preferably, the distance is equal to one third of the height of the bag plus or minus five percent of the height of the bag (between 28% and 38% of the height of the bag).

According to a second aspect of the invention, there is provided a sampling assembly comprising a plastic sampling bag according to the first aspect of the invention and a mixer for preparing samples with a view to permitting the performance of microbiological analyses and/or tests. The mixer and the sampling bag can be considered to form a combination or a kit for the preparation of a sample. In embodiments of the invention, the mixer is founded on a casing with an anterior wall formed by a mixer door. Embodiments of the mixer have one or more paddles that that exhibit peristaltic movement for mixing and bacterial extraction during blending.

The mixer door is pivotable about a horizontal axis in relation to the casing for selectively permitting the insertion and removal of the sampling bags relative to the inner volume of the mixer. The mixer door can be selectively locked in a closed position, such as by a lever. In practices of the invention, the sampling bag can be clamped along a bag clamping line between the mixer door and the casing. When in the closed position, the mixer door maintains the sampling bag in a fixed, closed configuration clamped along the bag clamping line.

The inner volume of the mixer provides a sampling bag compartment intended to receive the sampling bag and to act as a sampling chamber to permit a taking of volumes of the contents of the sampling bag after mixing and filtration. When the sampling bag is folded along the visual indicator, the sampling bag presents a height H_{F} corresponding to the original height of the bag minus the distance of the visual indicator from the opening. When the sampling bag is clamped along the bag clamping line, the portion of the sampling bag below the bag clamping line presents a clamping height H_{C} of the sampling bag from the bottom of the sampling bag to the bag clamping line. The sampling bag compartment of the mixer of the combination for the preparation of a sample has a mixer sampling bag compartment height HM that is calibrated to approximately match the clamping height H_{C} of the sampling bag when the sampling bag is clamped along the clamping line. The sampling bag clamping line is disposed proximal to the visual indicator such that the clamping height H_{C} of the sampling bag from the bottom of the sampling bag to the bag clamping line is less than the sampling bag height H_{F} when folded along the visual indicator.

According to a fourth aspect of the invention, there is provided a method of manufacturing a sampling bag intended to be used in combination with a laboratory mixer with a sampling bag compartment height HM for the preparation of samples with a view to carrying out microbiological analyses and/or tests. The sampling bag has a bottom, side walls, and an opening, and the sampling bag is compartmentalized by a filtering partition delimiting a chamber for receiving a sample and a sampling chamber serving to take samples. The method comprises a step of marking the sampling bag with a visual indicator of a correct, predetermined closing position of the bag after mixing, and the sampling bag has a sampling bag clamping line of a correct position of clamping the sampling bag between the mixer door and the mixer casing. The sampling bag clamping line is disposed proximal to the visual indicator of the closing position of the bag after mixing between that visual indicator and the bottom of the sampling bag such that the clamping height H_{C} of the sampling bag from the bottom of the sampling bag to the bag clamping line is less than the sampling bag height H_{F} when folded along the visual indicator.

The method according to the invention may further include, prior to the marking step, a step of determining the position of the visual indicator from the closed position of the bag in the mixer.

In certain embodiments, the filter sampling bag to be used in a mixer for the preparation of samples to permit analyses and/or microbiological tests can be formed of plastic material to have a bottom, side walls, a mouth opening, and a height. The sampling bag is compartmentalized by a filtering partition delimiting a receiving chamber for a sample and a sampling chamber for permitting a taking of samples. The sampling bag is marked with a visual indicator at a distance from the mouth opening indicative of a correct, predetermined fold position of a fold line for closure of the sampling bag after mixing. The sampling bag further includes a sampling bag clamping line of a correct position of clamping the sampling bag between the mixer door and the mixer casing. The sampling bag clamping line is disposed proximal to the visual indicator of the closing position of the bag after mixing, the sampling bag clamping line being between the visual indicator and the bottom of the sampling bag. The sampling bag clamping line can be established by and in relation to the sampling bag compartment of the mixer. The sampling bag clamping line can be additionally disposed on the sampling bag in a visually perceptible manner, such as by ink, etching, or another visually perceptible manner or a combination thereof.

Notably, the visual indicator and the sampling bag clamping line do not comprise or otherwise form a hermetic closure of the filter sampling bag. Instead, the visual indicator indicative of the correct, predetermined fold position of a fold line for closure of the sampling bag after mixing is operative to establish the predetermined, correct fold position and the folded height H_{F} of the sampling bag when folded along the visual indicator that is calibrated to approximately match the mixer compartment height HM of the sampling bag compartment while avoiding hermetic sealing as has often been required by the prior art. The visual indicator also avoids the capillary action of the bag contents to which sampling bags of the prior art are prone while retaining the desirable intrinsic qualities of the sampling bag, including easy opening and repetitive opening and closing, such as for pipetting, while also permitting the possible evacuation of gases, such as fermentation gases. Cross-contamination between sampling bags is prevented without the need for a hermetic closure and the limitations attendant thereto.

So disclosed, the sampling bag is a marked departure from previously taught bags requiring hermetic closure. For instance, with U.S. Patent Application Publication No. 2013/0139474, Coleman discloses a “collapsible bag or pouch for collecting samples of soil, mud, liquid and gases.” While from a different field of endeavor, Coleman teaches such a collapsible bag or pouch that has an “internal mechanical seal and a heat sealable area near the opening.” As disclosed by Coleman, the collapsible bag or pouch relies on a “profile extrusion in the opposing films to provide an interlocking closure, such as described in U.S. Pat. No. 4,561,109 and Re. 28,969 (e.g., a re-sealable zip type closure)” and then “a commercially-available heat sealing machine can be used to add additional, permanent seals.” Paras. [0018] and [0028].

The visual indicator of the fold position of the fold line for closure of the sampling bag can, for instance, be disposed on the sampling bag at a distance from the mouth opening equal to one third of the height of the bag plus or minus 5% of the height of the sampling bag to establish the correct folded sampling bag height H_{F} after mixing that is equal to approximately two thirds of the height of the sampling bag. The filtering partition can have an impregnated surface with a pore size cut-off threshold of approximately 280 microns in pore size. The pore size cut-off threshold thus refers to the pore size of the filtering partition, which can be measured in microns.

In practices of the invention, the visual indicator of the fold position of the fold line for closure of the sampling bag comprises a distinct line that traverses laterally across at least one of the side walls of the sampling bag. It is also disclosed that the visual indicator of the fold position of the fold line for closure of the sampling bag can comprise two distinct lines comprising a low line and a high line that traverse laterally across at least one of the side walls of the sampling bag. Embodiments of the sampling bag additionally include a graduation on one of the side walls of the sampling bag that has a maximum graduation level. The sampling bag additionally has a sampling bag clamping line of a correct position of clamping the sampling bag between the mixer door and the mixer casing. Again, the sampling bag clamping line can be established by and in relation to the sampling bag compartment of the mixer. The sampling bag clamping line can be additionally disposed on the sampling bag in a visually perceptible manner, such as by ink, etching, or another visually perceptible manner or a combination thereof. The sampling bag clamping line is disposed proximal to the visual indicator of the closing position of the bag after mixing, the sampling bag clamping line being between the visual indicator and the bottom of the sampling bag.

Embodiments of the invention can also be characterized as a set or a combination for the preparation of samples. Reference to a set or a combination for the preparation of samples is meant to indicate a number of things, such as the sampling bag and the mixer, that are used together to accomplish the preparation of samples of solid and/or nutrient and/or vegetable matter to carry out analyses and/or microbiological tests. A set for the preparation of samples could thus alternatively be referred to as a combination for the preparation of samples or a kit for the preparation of samples.

In any event, a combination for the preparation of samples according to the invention can include a mixer for preparing samples for performing analyses and/or microbiological tests and a sampling bag as taught herein. The mixer can be of the type shown and described herein or any other type except as may be excluded by the claims. The mixer is adapted for aiding in the suspension of the sample and/or solubilization of solid sample objects. The combination further includes a filter sampling bag that is formed of plastic material to have a bottom, side walls, a mouth opening, and a height. The sampling bag is compartmentalized by a filtering partition delimiting a receiving chamber for a sample and a sampling chamber for permitting a taking of samples.

The sampling bag is marked with a visual indicator of a correct, predetermined fold position of a fold line for closure of the sampling bag after mixing. The visual indicator is placed at a distance from the mouth opening. When the sampling bag is folded along the visual indicator, the sampling bag presents a height H_{F} corresponding to the original height of the bag minus the distance of the visual indicator from the opening. When the sampling bag is clamped along the bag clamping line, the portion of the sampling bag below the bag clamping line presents a clamping height H_{C} of the sampling bag from the bottom of the sampling bag to the bag clamping line. The sampling bag compartment of the mixer of the combination for the preparation of a sample has a mixer sampling bag compartment height HM that is calibrated to approximately match the clamping height H_{C} of the sampling bag as marked by the bag clamping line.

A kit for the preparation of samples, alternatively referred to as a sampling kit, according to the present invention comprises a kit of things used in combination for preparing samples for carrying out analyses and/or microbiological tests. The kit again comprises a mixer for preparing samples for performing analyses and/or microbiological tests. The mixer is adapted for aiding in suspension of the sample and/or solubilization of solid sample objects. The kit additionally comprises a filter sampling bag formed of plastic material to have a bottom, side walls, a mouth opening, and a height. The sampling bag is compartmentalized by a filtering partition delimiting a receiving chamber for a sample and a sampling chamber for permitting a taking of samples. The sampling bag is marked with a visual indicator of a correct, predetermined fold position of a fold line for closure of the sampling bag after mixing. The visual indicator is placed at a distance from the mouth opening, such as at a distance from the mouth opening equal to one third of the height of the bag plus or minus 5% of the height of the sampling bag. Again, a sampling bag compartment of the mixer has a compartment height HM that is calibrated to approximately match the clamping height H_{C} of the sampling bag according to the bag clamping line.

One will appreciate that the foregoing discussion broadly outlines the more important goals and features of the invention to enable a better understanding of the detailed description that follows and to instill a better appreciation of the inventor's contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

Other advantages and features of the invention will become apparent on reading the detailed description of implementations and embodiments, which are in no way limiting, with regard to the accompanying drawings, in which:

FIG. 1 is a schematic depiction of an open sampling bag according to the prior art prior to a mixing step;

FIG. 2 is a schematic depiction of the prior art sampling bag of FIG. 1 pinched along a pinching line in the mixing step;

FIG. 3 is a schematic depiction of the prior art sampling bag of FIG. 2, unpinned, subsequent to the mixing step;

FIG. 4 is a schematic depiction of the prior art sampling bag of FIG. 3 closed after closing along a fold line arranged under the clamping line subsequent to the step shown in FIG. 3;

FIG. 5 is a schematic depiction of a sampling bag according to the present invention subsequent to a mixing step;

FIG. 6 is a schematic depiction of a collection bag according to the invention, closed after closing along a fold line, subsequent to an opening step shown in FIG. 5;

FIG. 7 is a schematic depiction of an alternative embodiment of a sampling bag according to the present invention;

FIG. 8 is a perspective view of a sampling bag according to the present invention during insertion into a mixer also according to embodiments of the present invention; and

FIG. 9 is a cross-sectional view in front elevation of the sampling bag disposed within the sampling bag compartment of the mixer, wherein the sampling bag compartment has a height HM calibrated to approximately match the clamping height H_{C} of the sampling bag when the sampling bag is clamped along the sampling bag clamping line.

### DETAILED DESCRIPTION OF PREFERRED EMBODIMENTS

The sampling bag disclosed herein is subject to varied embodiments, each within the scope of the invention. However, to ensure that one skilled in the art will be able to understand and, in appropriate cases, practice the present invention, certain preferred embodiments of the broader invention revealed herein are described below. The embodiments shown and described herein are not limiting. Variants of the disclosed embodiments may incorporate only a selection of characteristics described, potentially isolated from other described characteristics, particularly where the selection of characteristics is sufficient to confer a technical advantage or to differentiate from the state of the prior art. Sampling bags within the scope of the invention may thus incorporate one or more characteristics, perhaps functional without being limited relative to particular structural details or with only part of the structural details, where sufficient to confer a technical advantage or to differentiate the invention from the state of the prior art.

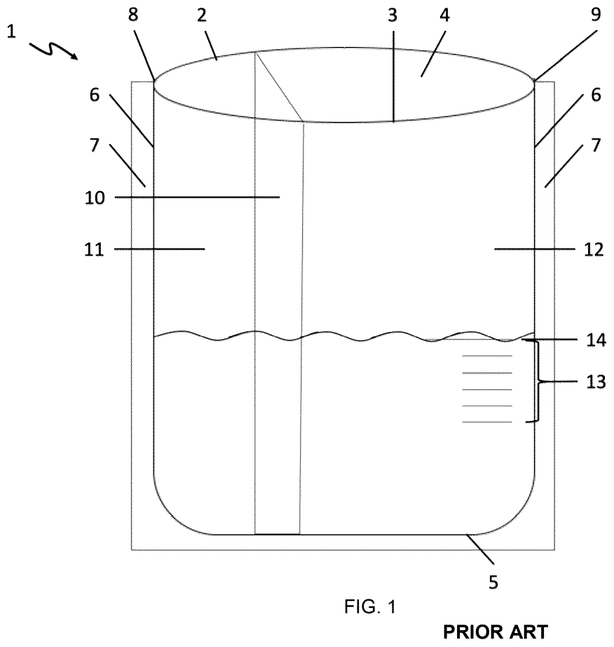

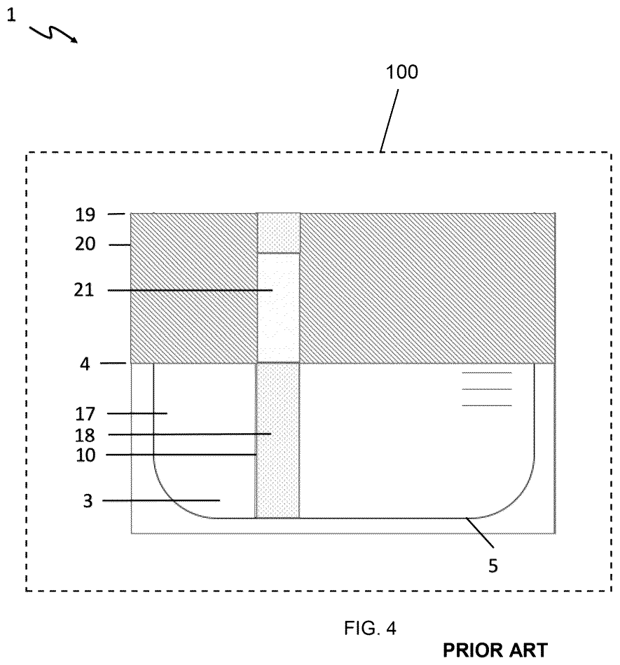

With further reference to the drawings, where like reference numerals are applied to like elements in the several figures, FIG. 1 illustrates a polyethylene collection bag 1 according to the prior art intended for use in a mixer, which is schematically illustrated and indicated at 100 in FIG. 4, for preparing samples for performing analyses and/or microbiological tests. The collection bag 1 may alternatively be referred to as a filter sampling bag 1. Samples can be solid and/or liquid. The collection bag 1 has two walls 2, 3 extending from top to bottom between a mouth opening 4 and a bottom 5 and extending, laterally, between two inner side edges 6.

According to embodiments presented, the lateral inner edges 6 are substantially parallel to each other. The sampling bag 1 is, in certain practices, manufactured by thermoforming two sheets of polyethylene by forming a fold 7 connecting two lateral ends 8, 9 of the opening 4, and extending along a first lateral inner edge 6, then along bottom 5 of the bag 1, and then along a second inner side edge 6 of the bag 1.

The bag 1 is compartmentalized by a filter partition 10 to define a first chamber 11 for receiving a sample and a second, sampling chamber 12 for permitting a taking of filtered samples from the bag 1.

The filtering partition 10 can, for instance, be made of polypropylene with a pore size cut-off threshold, such as of approximately 280 microns. The wall 3 has a graduation 13 comprising a series of parallel markings on one of the walls 2, 3. The graduation 13 can have a maximum graduation level 14 indicative of the maximum level of sample material to be received by the sampling bag 1 to be observed for correct use of the bag 1 in the mixer 100.

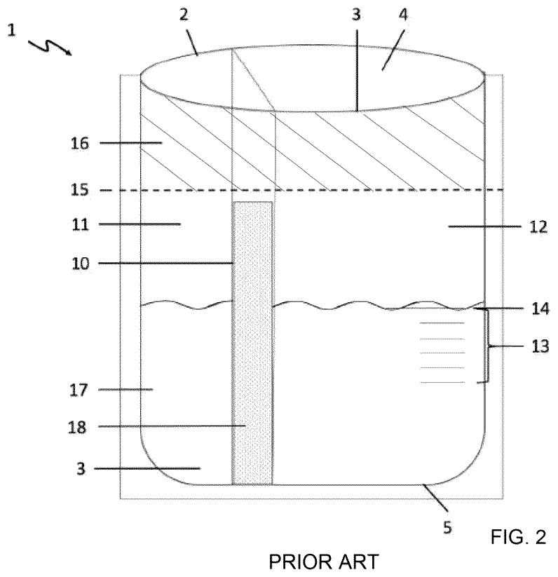

Referring to FIG. 2, when the prior art sampling bag 1 is introduced into the mixer 100, it is clamped along a clamping or pinch line, which is here drawn in dotted lines and indicated at 15. The clamping along the pinch line 15 is designed to make the sampling bag 1 liquid-tight during mixing.

Of course, air can escape from the sampling bag 1 past the pinch line 15, such as during mixing. The clamping line 15 can be considered to divide the bag 1 into an upper part 16 to the side of the mouth opening 4 of the bag 1 and a lower part 17 of the bag 1 to the side of the bottom 5 of the bag 1.

In FIG. 2, the upper part 16 is shown with a filling pattern with diagonal stripes extending from an upper left part to a lower right part. When the sampling bag 1 thus made liquid-tight by squeezing is stirred in the mixer 100, the sample is suspended in its liquid or optionally in an added diluent.

Referring again to FIG. 2, there is shown a soiled surface 18, which may alternatively be referred to as an impregnated surface 18. The soiled surface 18 is represented by a striped fill pattern with alternating vertical lines. In the diagram, the top level of the impregnated surface 18 is drawn at a level slightly below the pinch line 15, although it is noted that the the top level of the impregnated surface 18 could well be at the same level as the pinch line 15. Although the impregnated surface 18 is shown only over the width of the filter partition 10, the width of the soiled surface 18 extends over the entire bag 1, the liquid having circulated in the lower part 17 under the effect of the kneading of the mixer 100.

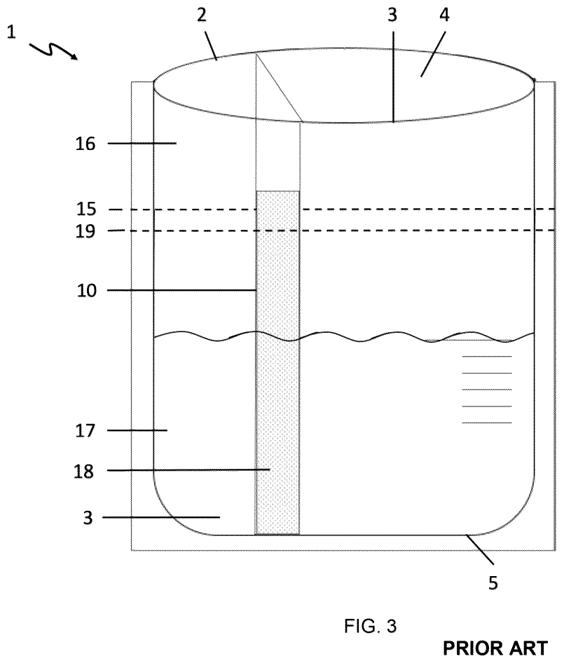

FIG. 3 schematically illustrates the state of impregnation of a prior art sampling bag 1 after it has passed through and been removed from the mixer 100. The sampling bag 1 is then no longer pinched along the pinch line 15.

The filtering partition 10 acts as a blotter. The suspension present at the level of the soiled surface 18 can rise by capillary action along the filtering partition 10, potentially invisibly or imperceptibly. The high level of the soiled surface 18 containing a potentially contaminating liquid can be found, again by capillary action, slightly above the clamping line 15.

With reference to FIGS. 3 and 4, it will be understood that closing the sampling bag 1 at a fold line 19 located below the top level of the pinch line 15 will result in a spill of potentially contaminating material outside of the prior art sampling bag 1 as is illustrated in FIG. 4.

In the example shown in FIG. 4, an upper part of the sampling bag 1 is folded over the wall 3 along fold line 19. According to another possibility and with reference to FIG. 3, the upper part of the sampling bag 1 could be folded over the wall 2.

When folded along the fold line 19, the upper part 20 of the filter wall 10 at the fold line 19 is folded down and contains any portion of the liquid contained in the sampling bag 1 in the filter wall 10 above the filter wall folding line 19. Under the effect of gravity, this part of contaminating liquid flows via the not-yet-impregnated part 21 of the filter partition 10 until it spills out of the bag 1 through the mouth opening 4. The flow of liquid creates a depression in the filtering partition 10 such that a siphon can be started. The flow will continue until the contents of the sampling bag 1 are almost completely emptied.

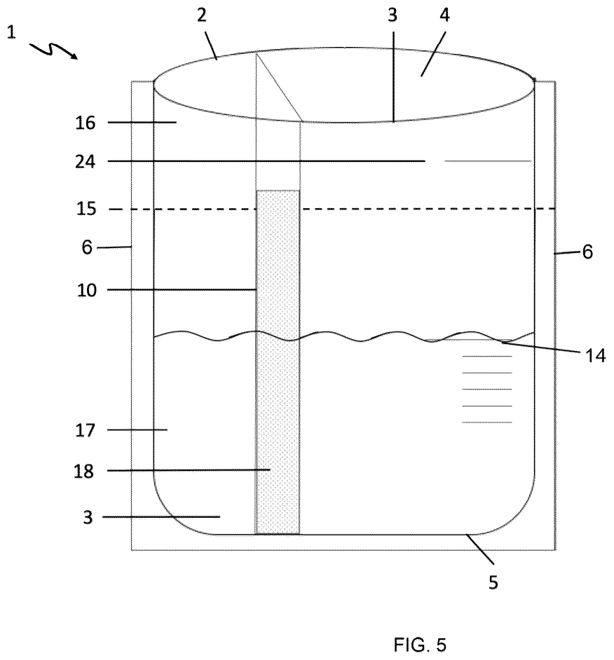

A sampling bag according to the present invention is indicated at 1 in FIG. 5. There, the sampling bag 1 again has first and second walls 2, 3 that extend longitudinally from top to bottom of the bag 1 from a mouth opening 4 to a bottom 5 and that extend laterally between two inner side edges 6. The inner side edges 6 are substantially parallel to one other. In certain embodiments, the sampling bag 1 can be manufactured by thermoforming two sheets of polyethylene in a manner similar to the prior art as previously described.

The bag 1 is compartmentalized by a filter partition 10 to define a first chamber 11 for receiving a sample and a second, sampling chamber 12 for permitting a taking of filtered samples from the bag 1. The filtering partition 10 can be made of polypropylene with a pore size cut-off threshold, such as of approximately 280 microns. The wall 3 has a graduation 13 comprising a series of parallel markings on the walls 3. The graduation 13 has a maximum graduation level 14 indicative of the maximum level of sample material to be received by the sampling bag 1 to be observed for correct use of the bag 1 in the mixer 100.

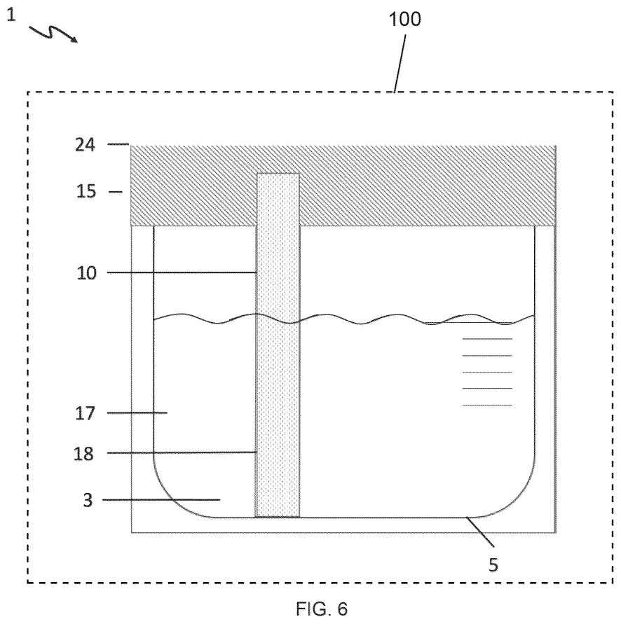

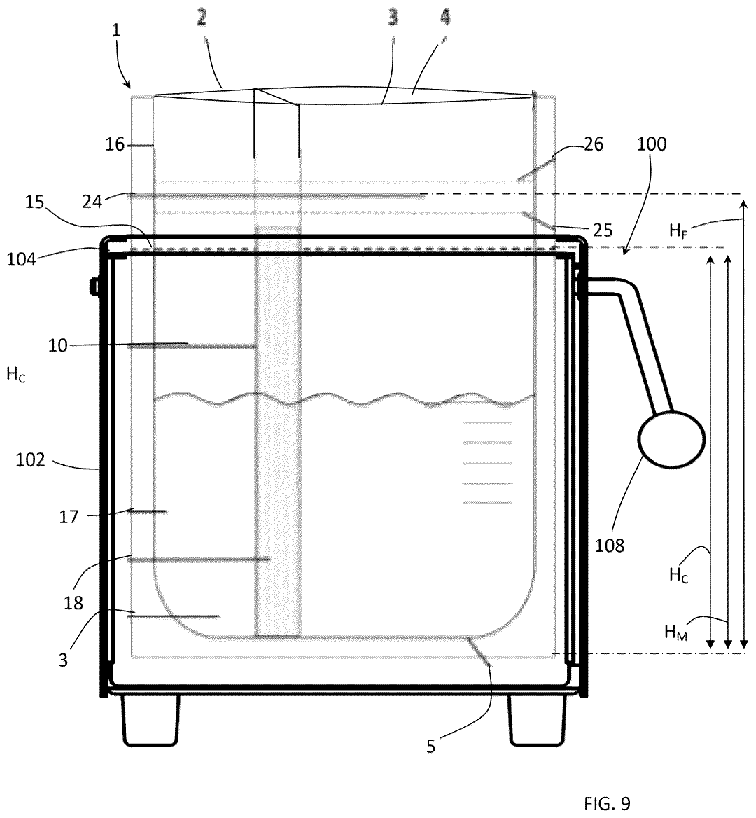

The sampling bag 1 is marked with a visual indicator 24 of a correct, predetermined closing or folding position of the bag 1. As disclosed herein, the visual indicator 24 alleviates the risk of the medium contained in the sampling bag 1 spilling outside the bag 1 or from otherwise leaking, such as by capillary action. The visual indicator 24 indicates the correct, predetermined fold position of a fold line for closure of the sampling bag 1 after mixing. The visual indicator 24 is placed at a distance from the mouth opening 4 to establish a correct folded sampling bag height H_{F} after mixing as is indicated in FIG. 9. When the sampling bag 1 according to the invention is folded along the fold line at the level of the visual indicator 24 as shown in FIG. 6, there is no risk of contamination beyond the closure of the bag 1 so established. As referenced herein, therefore, the correct closure indicator 24 is an indicator that allows closure of the sampling bag 1 after mixing to prevent potentially contaminating capillary leaks, rising contaminants, and upwelling and subsequent spillage of those contaminants outside the sampling bag 1.

The visual indicator 24 of a predetermined correct closing position of the sampling bag 1 after mixing avoids capillary leaks and rising contaminants from being poured or spilled from the sampling bag 1. Advantageously, the visual indicator 24 establishes an indication of a correct closure by folding that allows closure of the bag 1 in a manner that prevents potentially contaminating capillary leaks rising and spilling outside of the bag 1 while not requiring a hermetic sealing of the sampling bag 1.

The visual indicator 24 can take a variety of forms within the scope of the invention. In certain, non-limiting embodiments, the visual indicator 24 can comprise a distinct line that traverses laterally across either or both walls 2 and 3 generally parallel to the bottom 5 and to the edges of the walls 2 and 3 defining the opening 4 as shown in FIG. 5. The distinct line forming the visual indicator 24 could be applied in any effective manner or combination of manners, such as by ink, by etching, or by any other method of combination thereof.

The visual indicator 24 does not comprise or otherwise form a hermetic closure of the filter sampling bag 1, and, in preferred embodiments, the filter sampling bag 1 does not include any mechanism for providing a hermetic closure, such as through mechanical seal components or heat sealing. Instead, the visual indicator 24 indicative of the correct, predetermined fold position of a fold line for closure of the sampling bag 1 after mixing is operative to establish the predetermined, correct fold position while avoiding hermetic sealing as has often been required by the prior art. The visual indicator 24 also avoids leakage, including through the capillary action of the bag contents to which sampling bags of the prior art are prone while retaining the desirable intrinsic qualities of the sampling bag 1. Without a need for a hermetic closure, the sampling bag 1 can be easily opened and closed repetitively, such as for pipetting. The sampling bag 1 also permits fermentation gases to be evacuated as needed. As a result, cross-contamination between sampling bags 1 is prevented without the need for a hermetic closure and the limitations attendant thereto.

The sampling bag 1 additionally has a sampling bag clamping line 15 that is proximal to the visual indicator 24 of the predetermined fold line with respect to the bottom 5 of the sampling bag. The sampling bag clamping line corresponds to a correct position of clamping the sampling bag between the mixer door and the mixer casing. The sampling bag clamping line can be established by and in relation to the sampling bag compartment of the mixer. The sampling bag clamping line can be additionally disposed on the sampling bag in a visually perceptible manner, such as by ink, etching, or another visually perceptible manner or a combination thereof. The sampling bag clamping line 15 in this embodiment is depicted as a dotted line, but such need not be the case. The sampling bag clamping line 15 can take a variety of forms within the scope of the invention. In certain embodiments, the sampling bag clamping line 15 comprises a distinct line that traverses laterally across either or both walls 2 and 3 generally parallel to the bottom 5 and to the edges of the walls 2 and 3 defining the opening 4 as shown. The distinct line forming the clamping line 15 could be applied in any effective manner or combination of manners, such as by ink, by etching, or by any other method of combination thereof, but it will be understood that it is within the scope of the invention for the sampling bag clamping line to be established by the clamping of the sampling bag between the mixer door 104 and the mixer casing 102.

When the sampling bag 1 is clamped along the bag clamping line 15 by the door 104 of the mixer 100, the portion of the sampling bag 1 below the bag clamping line 15 presents a clamping height H_{C} of the sampling bag 1 from the bottom 5 of the sampling bag 1 to the bag clamping line 15. The sampling bag compartment of the mixer 100 of the combination for the preparation of a sample has a mixer sampling bag compartment height HM that is calibrated to approximately match the clamping height H_{C} of the sampling bag 1 when the sampling bag 1 is clamped by the mixer 100 along the visual indicator provided by the clamping line 15.

The inner volume of the mixer 100 provides a sampling bag compartment intended to receive the sampling bag and to act as a sampling chamber to permit a taking of volumes of the contents of the sampling bag after mixing and filtration. When the sampling bag is folded along the visual indicator, the sampling bag presents a height H_{F} corresponding to the original height of the bag minus the distance of the visual indicator from the opening. When the sampling bag is clamped along the bag clamping line, the portion of the sampling bag below the bag clamping line presents a clamping height H_{C} of the sampling bag from the bottom of the sampling bag to the bag clamping line. The clamping height H_{C} is less than the height H_{F} of the sampling bag when folded along the visual indicator. The sampling bag compartment of the mixer of the combination for the preparation of a sample has a mixer sampling bag compartment height HM that is calibrated to match the clamping height H_{C} of the sampling bag. The sampling bag clamping line is disposed proximal to the visual indicator such that the clamping height H_{C} of the sampling bag from the bottom of the sampling bag to the bag clamping line is less than the sampling bag height H_{F} when folded along the visual indicator.

The sampling bag 1 so shown and described departs from previously taught bags requiring hermetic closure. For instance, with U.S. Patent Application Publication No. 2013/0139474, Coleman discloses a “collapsible bag or pouch for collecting samples of soil, mud, liquid and gases.” Coleman, which again is from a different field of endeavor, teaches a collapsible bag or pouch that has an “internal mechanical seal and a heat sealable area near the opening . . . .” As disclosed by Coleman, the collapsible bag or pouch relies on a “profile extrusion in the opposing films to provide an interlocking closure, such as described in U.S. Pat. No. 4,561,109 and Re. 28,969 (e.g., a re-sealable zip type closure)” and then “a commercially-available heat sealing machine can be used to add additional, permanent seals.” Paras. [0018] and [0028]. Neither mechanical seals, heat sealing, nor any other hermetic closure is required or included in embodiments of the present invention.

As disclosed herein, the line position of the visual indicator 24 can be determined with knowledge of the sampling bag clamping line 15 within the mixer 100. The mixer 100 thus cooperates with the sampling bag 1 to form a combination or kit for the preparation of samples. The visual indicator 24 is placed between the bag clamping line 15 and the mouth opening 4, such as approximately in the middle between the bag clamping line 15 and the mouth opening 4. In certain embodiments, the visual indicator 24 is disposed at a distance from the opening 4 located at one third of the height of the sampling bag 1, plus or minus 5% of the height, and the bag clamping line 15 is disposed proximal to the visual indicator 24 with respect to the bottom 5 of the sampling bag 1.

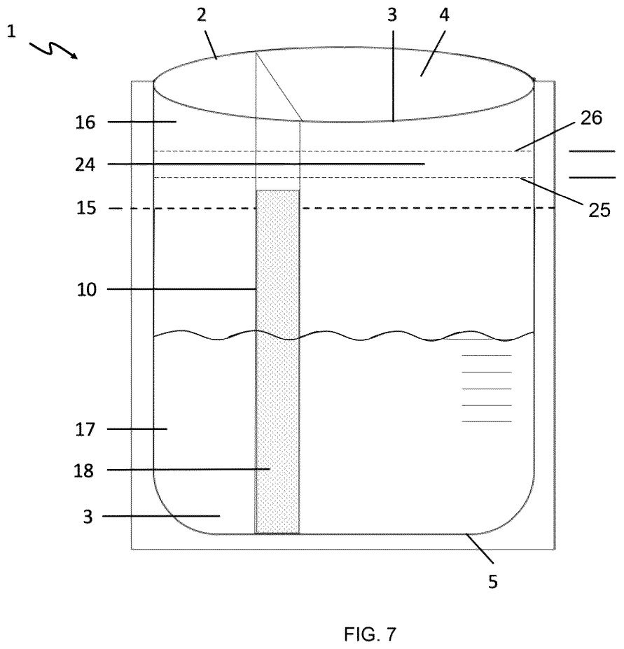

In embodiments of the invention, the visual indicator 24 can be formed with two distinct lines. In particular, as shown in FIG. 7, the visual indicator 24 can have a low line 25 and a high line 26 that together form a visual indicator 24 of the fold position. The visual indicator 24 thus establishes not only whether the fold actually made in the sampling bag 1 after mixing is too low but also whether it is too high.

There is thus also proposed according to the invention a kit or combination for the preparation of samples comprising a mixer 100 for preparing samples with a view to performing analyzes and/or microbiological tests and a sampling bag 1 as has previously shown and described. The ideal folding height H_{F} of the sampling bag 1 can then be perfectly known with respect to the particular mixer 100 of the present invention in view of the sampling bag clamping line 15 within the mixer 100.

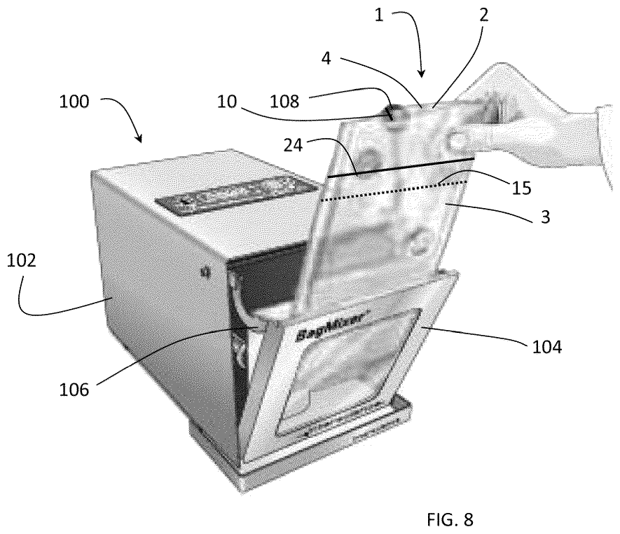

The construction of the mixer 100 may vary within the scope of the invention except as expressly limited by the claims. One ideal mixer 100 for use according to the present invention is sold under the name BagMixer by Interscience, a French SARL, of Saint Nom la Bretèche, France. Such a mixer 100 is illustrated in FIG. 8 with a sampling bag 1 according to the present invention being inserted therein for mixing. The mixer 100 is founded on a casing 102 with an anterior wall formed by a mixer door 104 that is pivotable about a horizontal axis in relation to the casing 102 for selectively permitting the insertion and removal of sampling bags 1 relative to the inner volume of the mixer 100. The mixer door 104 has a window therein for enabling an observation of the mixing process and the status thereof. A lever 108 is operative to selectively lock the mixer door 104 in a closed position. When in the closed position, the mixer door 104 maintains the sampling bag 1 in a fixed, closed configuration by clamping the sampling bag 1 along the sampling bag clamping line 15 thereby further reducing the risk of any leaks from the sampling bag 1. The mixer 100 has paddles 106 that that exhibit peristaltic movement for optimal mixing and bacterial extraction during blending. The mixer 100 thus rapidly and efficiently prepares samples for performing analyses and, additionally or alternatively, microbiological tests. The mixer 100 is adapted for aiding in suspension of the sample and, additionally or alternatively, solubilization of solid sample objects.

The inner volume of the casing 102 of the mixer 100 thus provides a sampling bag compartment intended to receive the sampling bag 1 and to act as a sampling chamber to permit a taking of volumes of the contents of the sampling bag 1 after mixing and filtration. With reference to FIG. 9, when the sampling bag 1 is folded along the visual indicator 24, the sampling bag 1 presents a height H_{B} corresponding to the original height of the bag 1 minus the distance of the visual indicator 24 from the opening 4. The sampling bag compartment of the mixer 100 of the combination for the preparation of a sample has a height HM from the support provided by the mixer 100 for the bag 1 to the location where the mixer door 104 clamps the sampling bag 1 between it and the casing 102 that is calibrated to approximately match the clamping height H_{C} of the sampling bag 1 when the sampling bag 1 is clamped within the mixer 100.

Finally, there is proposed a method of manufacturing a sampling bag 1 intended to be used in a mixer 100 for the preparation of samples with a view to performing analyses and/or microbiological tests having a bottom 5, side walls 2, 3, and an opening 4, the sampling bag 1 being compartmentalized by a filtering partition 10 delimiting a first chamber 11 for receiving a sample and a second, sampling chamber 12 serving to take samples, the method comprising a step of marking the sampling bag 1 so formed with a visual indicator 24 of a correct, predetermined closing position of the sampling bag 1 after mixing. When the sampling bag 1 is folded along the visual indicator 24, the sampling bag 1 has an effective height H_{F}. The sampling bag 1 is further formed with a bag clamping line 15 that is proximal to the visual indicator 24 with respect to the bottom 5 of the bag 1 that approximately matches the height H_{C} of the sampling bag compartment of the mixer 100 of the combination. The method can further include, prior to the marking step, a step of determining the position of the visual indicator 24 with respect to the position of the clamping bag line 15 from the closed position of the sampling bag 1 in the mixer 100.

Of course, the invention is not limited to the examples which have just been described. Numerous modifications can be made to these examples without departing from the scope of the invention. In addition, the different characteristics, shapes, variants and embodiments of the invention can be associated with each other in various combinations as long as they are not incompatible with or exclusive of each other.

When introducing elements of the present invention or embodiments thereof, the articles “a,” “an,” and “the” are intended to mean that there are one or more of the elements. The terms “comprising,” “including,” and “having” are intended to be inclusive such that there may be additional elements other than the listed elements. As used herein, terms such as “example” or “exemplary” are not intended to imply a superlative example. Rather, “exemplary” refers to an embodiment that is one of many possible embodiments.

With certain details and embodiments of the present invention for a sampling bag 1, for a combination or kit for the preparation of samples, and for a method of manufacturing a sampling bag 1 disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein. Accordingly, it will be clear that those with major features of the invention in mind could craft embodiments that incorporate those major features while not incorporating all of the features included in the preferred embodiments.

Therefore, the following claims shall define the scope of protection to be afforded to the invention. Those claims shall be deemed to include equivalent constructions insofar as they do not depart from the spirit and scope of the invention. It must be further noted that a plurality of the following claims may express, or be interpreted to express, certain elements as means for performing a specific function, at times without the recital of structure or material. As the law demands, any such claims shall be construed to cover not only the corresponding structure and material expressly described in this specification but also all legally-cognizable equivalents thereof.

What is claimed as deserving the protection of Letters Patent:

1. A filter sampling bag to be used in a mixer for the preparation of samples to permit analyses and/or microbiological tests, wherein the sampling bag is formed of plastic material, wherein the sampling bag has a bottom, side walls, a mouth opening, and a height, wherein the sampling bag is compartmentalized by a filtering partition delimiting a receiving chamber for a sample and a sampling chamber for permitting a taking of samples, wherein the sampling bag is marked with a visual indicator of a correct, predetermined fold position of a fold line for closure of the sampling bag after mixing, and wherein the visual indicator is placed at a distance from the mouth opening to establish a correct folded sampling bag height H_{F} after mixing.

2. The filter sampling bag of claim 1, wherein the visual indicator of the fold position of the fold line for closure of the sampling bag is disposed on the sampling bag at a distance from the mouth opening equal to one third of the height of the bag plus or minus 5% of the height of the sampling bag to establish a correct folded sampling bag height H_{F} after mixing that is equal to approximately two thirds of the height of the sampling bag.

3. The filter sampling bag of claim 2, wherein the visual indicator of the fold position of the fold line for closure of the sampling bag is disposed on the sampling bag at a distance from the mouth opening equal to one third of the height of the sampling bag.

4. The filter sampling bag of claim 1, wherein the filtering partition has an impregnated surface with a pore size cut-off threshold of approximately 280 microns.

5. The filter sampling bag of claim 1, wherein the visual indicator of the fold position of the fold line for closure of the sampling bag comprises a distinct line that traverses laterally across at least one of the side walls of the sampling bag.

6. The filter sampling bag of claim 1, wherein the visual indicator of the fold position of the fold line for closure of the sampling bag comprises two distinct lines comprising a low line and a high line that traverse laterally across at least one of the side walls of the sampling bag.

7. The filter sampling bag of claim 1, further comprising a graduation on one of the side walls of the sampling bag wherein the graduation has a maximum graduation level.

8. The filter sampling bag of claim 1, wherein the sampling bag further has a sampling bag clamping line that is proximal to the visual indicator of the correct, predetermined fold position with respect to the bottom of the sampling bag wherein the sampling bag below the sampling bag clamping line presents a clamping height H_{C} of the sampling bag from the bottom of the sampling bag to the sampling bag clamping line that is less than the correct folded sampling bag height H_{F} indicated by the visual indicator.

9. A combination for the preparation of samples of solid and/or nutrient and/or vegetable matter to carry out analyses and/or microbiological tests, the combination comprising a mixer for preparing samples for performing analyses and/or microbiological tests, the mixer adapted for aiding in suspension of the sample and/or solubilization of solid sample objects and a filter sampling bag, wherein the mixer has a casing and a mixer door that cooperate to define a sampling bag compartment with a height HM, wherein the sampling bag is formed of plastic material, wherein the sampling bag has a bottom, side walls, a mouth opening, and a height, wherein the sampling bag is compartmentalized by a filtering partition delimiting a receiving chamber for a sample and a sampling chamber for permitting a taking of samples, and wherein the sampling bag is marked with a visual indicator of a correct, predetermined fold position of a fold line for closure of the sampling bag after mixing, wherein the visual indicator is placed at a distance from the mouth opening, wherein the sampling bag has a correct folded sampling bag height H_{F} when the sampling bag is folded to form the fold line along the visual indicator of the correct, predetermined fold position, and wherein the height H_{F} when the sampling bag is folded to form the fold line along the visual indicator is greater than the height HM of the sampling bag compartment of the mixer.

10. The combination for the preparation of samples of claim 9, wherein the visual indicator of the fold position of the fold line for closure of the sampling bag is disposed on the sampling bag at a distance from the mouth opening equal to one third of the height of the bag plus or minus 5% of the height of the sampling bag to establish the correct folded sampling bag height H_{F} after mixing that is equal to approximately two thirds of the height of the sampling bag.

11. The combination for the preparation of samples of claim 10, wherein the visual indicator of the fold position of the fold line for closure of the sampling bag is disposed on the sampling bag at a distance from the mouth opening equal to one third of the height of the sampling bag.

12. The combination for the preparation of samples of claim 9, wherein the filtering partition has an impregnated surface with a pore size cut-off threshold of approximately 280 microns.

13. The combination for the preparation of samples of claim 9, wherein the visual indicator of the fold position of the fold line for closure of the sampling bag comprises a distinct line that traverses laterally across at least one of the side walls of the sampling bag.

14. The combination for the preparation of samples of claim 9, wherein the visual indicator of the fold position of the fold line for closure of the sampling bag comprises two distinct lines comprising a low line and a high line that traverse laterally across at least one of the side walls of the sampling bag.

15. The combination for the preparation of samples of claim 9, wherein the filter sampling bag further comprises a graduation on one of the side walls of the sampling bag wherein the graduation has a maximum graduation level.

16. The combination for the preparation of samples of claim 9, wherein the sampling bag further has a sampling bag clamping line that is proximal to the visual indicator of the correct, predetermined fold position with respect to the bottom of the sampling bag wherein the sampling bag below the sampling bag clamping line presents a clamping height H_{C} of the sampling bag from the bottom of the sampling bag to the sampling bag clamping line that is less than the correct folded sampling bag height H_{F} indicated by the visual indicator.

17. The combination for the preparation of samples of claim 16, wherein the height HM of the sampling bag compartment approximately matches the clamping height H_{C} on the sampling bag when the sampling bag is clamped along the sampling bag clamping line.

18. A kit for the preparation of samples for carrying out analyzes and/or microbiological tests, the sampling kit comprising a mixer for preparing samples for performing analyses and/or microbiological tests, the mixer adapted for aiding in suspension of the sample and/or solubilization of solid sample objects and a filter sampling bag, wherein the mixer has a casing and a mixer door that cooperate to define a sampling bag compartment with a height H_{C}, wherein the sampling bag is formed of plastic material, wherein the sampling bag has a bottom, side walls, a mouth opening, and a height, wherein the sampling bag is compartmentalized by a filtering partition delimiting a receiving chamber for a sample and a sampling chamber for permitting a taking of samples, and wherein the sampling bag is marked with a visual indicator of a correct, predetermined fold position of a fold line for closure of the sampling bag after mixing, wherein the visual indicator is placed at a distance from the mouth opening, wherein the sampling bag has a correct folded sampling bag height H_{F} when the sampling bag is folded to form the fold line along the visual indicator of the correct, predetermined fold position, and wherein the height H_{F} when the sampling bag is folded to form the fold line along the visual indicator is greater than the height HM of the sampling bag compartment of the mixer.

19. The kit of claim 18, wherein the visual indicator of the fold position of the fold line for closure of the sampling bag is disposed on the sampling bag at a distance from the mouth opening equal to one third of the height of the bag plus or minus 5% of the height of the sampling bag to establish the correct folded sampling bag height H_{F} after mixing that is equal to approximately two thirds of the height of the sampling bag.

20. The kit of claim 19, wherein the visual indicator of the fold position of the fold line for closure of the sampling bag is disposed on the sampling bag at a distance from the mouth opening equal to one third of the height of the sampling bag.

21. The kit of claim 18, wherein the filtering partition has an impregnated surface with a pore size cut-off threshold of approximately 280 microns.

22. The kit of claim 18, wherein the visual indicator of the fold position of the fold line for closure of the sampling bag comprises a distinct line that traverses laterally across at least one of the side walls of the sampling bag.

23. The kit of claim 18, wherein the visual indicator of the fold position of the fold line for closure of the sampling bag comprises two distinct lines comprising a low line and a high line that traverse laterally across at least one of the side walls of the sampling bag.

24. The kit of claim 18, wherein the filter sampling bag further comprises a graduation on one of the side walls of the sampling bag wherein the graduation has a maximum graduation level.

25. The kit of claim 18, wherein the sampling bag further has a sampling bag clamping line that is proximal to the visual indicator of the correct, predetermined fold position with respect to the bottom of the sampling bag wherein the sampling bag below the sampling bag clamping line presents a clamping height H_{C} of the sampling bag from the bottom of the sampling bag to the sampling bag clamping line that is less than the correct folded sampling bag height H_{F} indicated by the visual indicator.

26. The combination for the preparation of samples of claim 24, wherein the height HM of the sampling bag compartment approximately matches the clamping height H_{C} on the sampling bag when the sampling bag is clamped along the sampling bag clamping line.
